(19) United States
(12) Patent Application Publication
(10) Pub. No.: US 2025/0299645 A1
(43) Pub. Date: Sep. 25, 2025

(54) GATE DRIVING DEVICE CAPABLE OF SELECTIVE DRIVING

(71) Applicant: UNIVERSITY-INDUSTRY COOPERATION GROUP OF KYUNG HEE UNIVERSITY, Yongin-si (KR)

(72) Inventors: Hyoung Sik NAM, Incheon (KR); Ji oon KIM, Seoul (KR); Min Kyu CHANG, Incheon (KR)

(73) Assignee: UNIVERSITY-INDUSTRY COOPERATION GROUP OF KYUNG HEE UNIVERSITY, Yongin-si (KR)

(21) Appl. No.: 19/087,795

(22) Filed: Mar. 24, 2025

(30) Foreign Application Priority Data
Mar. 25, 2024 (KR) 10-2024-0040292

(51) Int. Cl. G09G 3/36; G09G 3/3266

(52) U.S. Cl. CPC G09G 3/3677; G09G 3/3266; G09G 2310/08; G09G 2330/021

(57) ABSTRACT

The present invention relates to a gate driving circuit with an output selection function for arbitrary selective driving. A gate driving device capable of selective driving according to one embodiment may include: a pulse signal generation unit configured to generate a pulse signal for a line, and a gate driving unit configured to selectively control the output value for an arbitrary line. The gate driving unit may include: a first transistor configured to control the activation or deactivation of the final output signal VOUT[n], a second transistor configured to pull down an input signal corresponding to the output signal to control whether the signal is output, and a third transistor configured to maintain pre-charging of the line.

### CROSS-REFERENCE TO RELATED APPLICATION

This application claims priority from and the benefit of Korean Patent Application No. 10-2024-0040292 filed on Mar. 25, 2024, in the Korean Intellectual Property Office, the disclosure of which is incorporated herein by reference.

### BACKGROUND OF THE DISCLOSURE

### Field of the Disclosure

Example embodiments relate to a gate driving device in which a gate driving circuit with an output selection function for arbitrary selective driving is used, and more specifically, to a TFT-based gate driving technology capable of reducing power consumption.

### Description of the Related Art

A gate driving circuit is primarily used in displays such as TFT-LCD (Thin-Film Transistor Liquid Crystal Display) or AMOLED (Active-Matrix Organic Light-Emitting Diode) to generate and control the output signals required to control each pixel of the display.

The gate driving circuit is one of the key components that directly affect the performance and image quality of the display. In a display, each pixel is generally composed of Thin-Film Transistors (TFTs), which maintain the pixel state until power is applied and allow the liquid crystal within the pixel to be illuminated when the pixel is activated. The gate driving circuit generates control signals for each pixel to activate or deactivate the TFTs.

Meanwhile, the gate driving circuit sequentially activates each row of the display and transmits pixel data to display an image. Therefore, the gate driving circuit plays a role in correctly transmitting pixel data to the display panel and controlling the refresh rate of the display screen.

Specifically, the gate driving circuit may generate a signal to turn on a single line of pixel circuits in the display panel. Generally, within one frame, signals sequentially turn on each line from the first to the last, updating the pixels of all lines. However, if the lines in static areas are not updated and are instead maintained, the driving frequency for those lines may be reduced, leading to lower power consumption.

By driving the video portions of the screen at a high frequency and the static image portions at a low frequency, power consumption in the static image areas may be minimized. Therefore, it is necessary to develop a TFT-based gate driving circuit that may equally reduce power consumption while overcoming the limitations of selective line-by-line refresh rate driving in gate driving circuits.

The conventional circuit (selective gate driver) diagram is shown in FIG. 1A, and the timing diagram of the circuit is illustrated in FIG. 1B.

Referring to conventional circuit papers, during the programming frame interval, the output pulse SL[n] of all lines must be output, and at the pulse output corresponding to the start line of the high-frequency driving area, VDATA is applied at a high voltage to store a high voltage value in the Me[n] node. Consequently, the MM2 of the shift register for the corresponding line remains on.

During the selective driving interval, the gate driving operation remains inactive until the Output Enable (OE) signal becomes low, and VDATA reaches a high voltage. At this point, through MM2, the shift register starts operating as an input, and at the last line of the high-frequency driving area, the Output Enable (OE) signal is again set to low, ensuring that pulses occur only in the designated area.

This conventional circuit requires storing the Me[n] node value during the programming frame interval for selective driving. At this time, an SL[n-1] pulse input is needed to turn MM1 on. Whenever the operating area changes, the Me[n] for the area must first be programmed during the programming frame interval before executing the selective driving interval. Additionally, since VDATA is shared, it is not possible to support multiple high-frequency driving areas within a single screen.

### SUMMARY

The present invention aims to provide a TFT-based gate driving circuit that overcomes the limitations of line-by-line selective refresh rate driving while equally reducing power consumption.

The present invention is designed to eliminate the need for a programming frame interval for selective driving and to control the output waveform solely through the Output Enable (OE) signal, thereby enabling support for multiple high-frequency regions.

Furthermore, the present invention aims to implement multiple regions within a single screen, each operating at different driving frequencies.

In one embodiment, a gate driving device capable of selective driving may include a pulse signal generation unit configured to generate a pulse signal for a line, and a gate driving unit configured to selectively control an output value for an arbitrary line. The gate driving unit may include: a first transistor configured to control the activation or deactivation of a final output signal (VOUT[n]), a second transistor configured to pull down an input signal corresponding to the output signal to control whether the signal is output, and a third transistor configured to maintain the pre-charging of the line.

In one embodiment, the second transistor may be configured to pull down the input signal using an output enable (OE) signal to control whether the signal is output.

In one embodiment, the third transistor may be connected to the output via the second transistor and may be configured to allow pre-charging of the corresponding line to occur before the voltage of the output enable (OE) signal changes.

In one embodiment, the pulse signal generation unit may include a shift register configured to generate a pulse signal based on a plurality of transistors.

In one embodiment, the first transistor may be configured to connect a Q node for generating a carry signal (Carry[n]) and a Q′ node for generating a final output signal (VOUT[n]).

In one embodiment, the Q node for generating a carry signal (Carry[n]) and the Q′ node for generating a final output signal (VOUT[n]) may be connected by the first transistor, and the first transistor may be controlled by an output enable (OE) signal.

In one embodiment, the first transistor may be turned on when the output enable (OE) signal is high, connecting the Q node for generating a carry signal (Carry[n]) and the Q′ node for generating a final output signal (VOUT[n]), such that the final output signal (VOUT[n]) and the carry signal (Carry[n]) are output simultaneously.

In one embodiment, the first transistor may disconnect the Q node from the Q′ node when the output enable (OE) signal is low, and the second transistor may pull down the Q′ node using the output enable (OE) signal when the carry signal (Carry[n]) is output, thereby blocking the output of the final output signal (VOUT[n]).

In one embodiment, the third transistor may be configured to control pre-charging of the corresponding line before the voltage of the output enable (OE) signal changes from low to high.

According to one embodiment, a TFT-based gate driving circuit may be provided that overcomes the limitations of line-by-line selective refresh rate driving while equally reducing power consumption.

According to one embodiment, a programming frame interval is not required for selective driving, and the output waveform may be controlled solely through the Output Enable (OE) signal, thereby supporting multiple high-frequency regions.

According to one embodiment, multiple regions with different driving frequencies may be implemented within a single screen.

### BRIEF DESCRIPTION OF THE FIGURES

Embodiments will be described in more detail with regard to the figures, wherein like reference numerals refer to like parts throughout the various figures unless otherwise specified, and wherein:

FIG. 1A is a diagram illustrating a selective gate driving circuit.

FIG. 1B is a diagram illustrating the timing of the gate driving circuit shown in FIG. 1A.

FIG. 2 is a diagram illustrating a gate driving device capable of selective driving according to one embodiment.

FIG. 3A is a diagram illustrating an example of a gate driving device.

FIG. 3B is a diagram illustrating an example of a gate driving device along with the detailed structure of a shift register.

FIGS. 4A to 4C are diagrams illustrating an embodiment for generating a one-line output pulse.

FIGS. 5A to 5C are diagrams illustrating an embodiment for generating seven-line output pulses.

FIGS. 6A and 6B are diagrams illustrating an embodiment for generating output pulses when multiple pulse intervals exist.

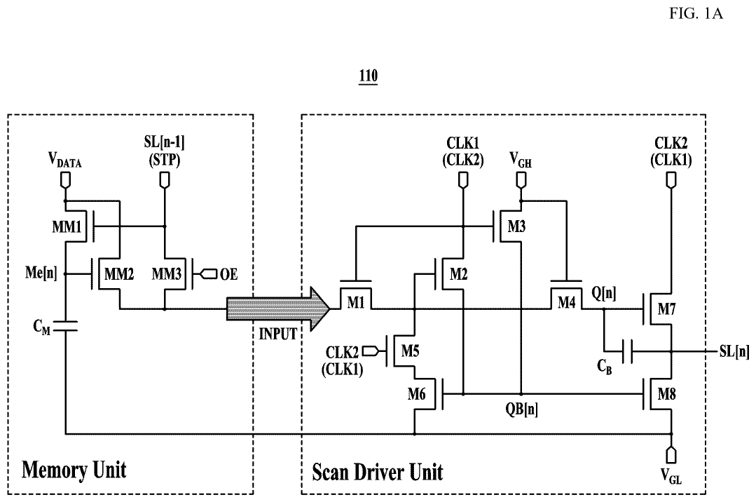

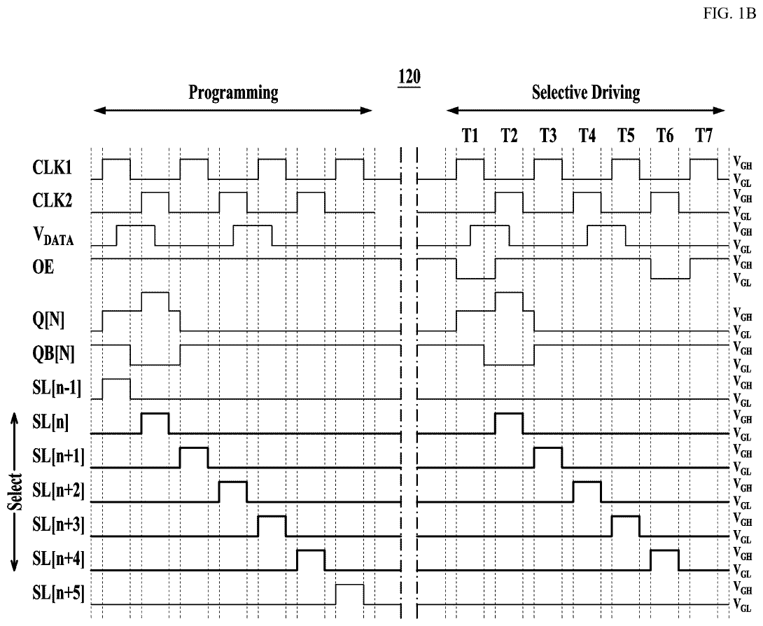

### DETAILED DESCRIPTION OF THE DISCLOSURE

The specific structural or functional descriptions of the embodiments according to the concept of the present invention disclosed in this specification are merely provided as examples for the purpose of explaining the embodiments according to the concept of the present invention. The embodiments according to the concept of the present invention may be implemented in various forms and are not limited to the embodiments described in this specification.

The embodiments according to the concept of the present invention may undergo various modifications and take different forms. Therefore, the embodiments are illustrated in the drawings and described in detail in this specification. However, this is not intended to limit the embodiments according to the concept of the present invention to specific disclosed forms, but rather to include modifications, equivalents, or substitutes that fall within the spirit and scope of the present invention.

Terms such as “first” and “second” may be used to describe various components, but these components should not be limited by these terms. These terms are used only to distinguish one component from another. For example, within the scope of the present invention, a first component may be referred to as a second component, and similarly, a second component may also be referred to as a first component without departing from the scope of the invention.

When a component is described as being “connected to” or “coupled to” another component, it should be understood that the component may be directly connected or coupled to the other component, or there may be an intervening component. In contrast, when a component is described as being “directly connected to” or “directly coupled to” another component, it should be understood that there are no intervening components. Similarly, expressions describing the relationships between components, such as “between” and “immediately between” or “adjacent to,” should be interpreted accordingly.

The terminology used in this specification is intended to describe particular embodiments only and is not intended to limit the invention. Unless the context clearly dictates otherwise, the singular form includes the plural form as well. In this specification, terms such as “include” or “have” are intended to specify that the stated features, numbers, steps, operations, components, or combinations thereof are present, but do not preclude the possibility of the presence or addition of one or more other features, numbers, steps, operations, components, or combinations thereof.

Unless otherwise defined, all terms used herein, including technical and scientific terms, have the same meaning as commonly understood by one of ordinary skill in the art to which this invention belongs. Terms defined in a commonly used dictionary should be interpreted as having meanings consistent with the context of the relevant technology and should not be interpreted in an idealized or overly formal sense unless explicitly defined in this specification.

The embodiments will be described in detail below with reference to the accompanying drawings. However, the scope of the patent application is not limited or restricted by these embodiments. The same reference numerals in the drawings indicate the same elements.

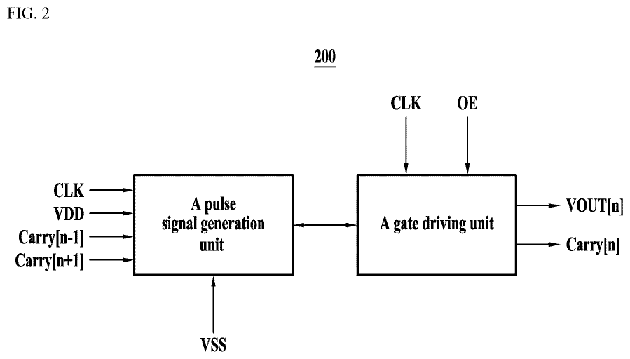

FIG. 2 is a diagram illustrating a gate driving device capable of selective driving 200 according to one embodiment.

Example embodiments relate to a gate driving device in which a gate driving circuit with an output selection function for arbitrary selective driving is used, and more specifically, to a TFT-based gate driving technology capable of reducing power consumption.

The gate driving device 200 according to one embodiment may include a pulse signal generation unit 210 and a gate driving unit 220.

The pulse signal generation unit 210 generates a pulse signal for a line to provide a gate driving device capable of selective driving for an arbitrary line.

The pulse signal generation unit 210 provides a gate driving device capable of selectively driving each line used in a TFT-LCD display. While a TFT-LCD display requires multiple gate drivers to control the pixels—each responsible for controlling a row of the display panel—this driving method is not limited to TFT-LCD technology. In fact, similar techniques are being actively explored and implemented in AMOLED (Active-Matrix Organic Light-Emitting Diode) displays, where precise gate driving is critical due to the unique characteristics of organic light-emitting diodes. Given the increasing adoption of AMOLED displays, various gate driving schemes, including the one described in this invention, are being studied to enhance display performance, reduce power consumption, and improve panel longevity. The pulse signal generation unit 210, by generating pulse signals for the lines to control these gate drivers, can be effectively applied to both TFT-LCD and AMOLED display technologies.

This pulse signal is sequentially delivered to each line of the display panel, enabling the activation of the gate driver for the corresponding line. Through this process, the TFT pixels of each line are properly activated, allowing the display to present images.

The pulse signal generation unit 210 may use a shift register to efficiently generate pulse signals. A shift register is a digital circuit element that moves serial data and converts it into parallel data. It may be used to process and convert serially transmitted data for pulse signal generation. This enables the generation of pulse signals for each line and allows effective control of the gate drivers in the display panel.

Additionally, the gate driving unit 220 includes a first transistor, a second transistor, and a third transistor, which allow the selective control of output values for an arbitrary line.

Specifically, the first transistor controls the activation or deactivation of the final output signal VOUT[n], while the second transistor pulls down an input signal corresponding to the output signal to control whether the signal is output. In particular, the first transistor is generally used to activate or deactivate the final output signal. This is essential for maintaining the output in an ON state or switching it to an OFF state.

Additionally, when the output enable (OE) signal drops from high to low, the second transistor prevents the issue where the Q′ node of the next line remains floating high, which could cause unintended output. That is, when the output enable (OE) signal transitions from high to low, the second transistor may pull down the input signal corresponding to the output signal.

As soon as the output enable (OE) signal drops to low, output is prevented from occurring. The second transistor is responsible for the pull-down operation on the input of the output signal. This function quickly deactivates and stabilizes a previously active output signal when transitioning to the OFF state. This is essential for maintaining circuit stability and optimizing power consumption.

Furthermore, the third transistor ensures that the pre-charging of the line operates correctly. Depending on the operation of these transistors, the output value for an arbitrary line may be selectively controlled.

The third transistor primarily performs the pre-charging operation for the line, which involves pre-charging the line before a specific operation takes place. This ensures that the line functions properly and facilitates smooth signal transmission. Additionally, the operation of the third transistor influences the overall operation of the gate driver circuit. By adjusting these transistors, the output value of an arbitrary line may be selectively controlled, allowing for the adjustment of the output value of specific lines in the display panel and control over the display's operation.

Additionally, the second transistor pulls down the input signal using the output enable (OE) signal to control whether the signal is output, while the third transistor connects the second transistor to the output and ensures that pre-charging of the corresponding line occurs before the voltage of the output enable (OE) signal changes.

The pulse signal generation unit 210 includes a shift register configured to generate a pulse signal based on a plurality of transistors.

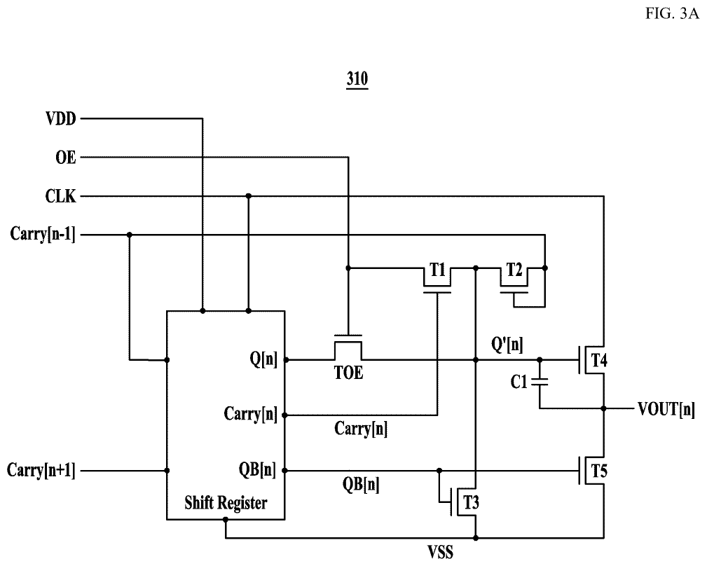

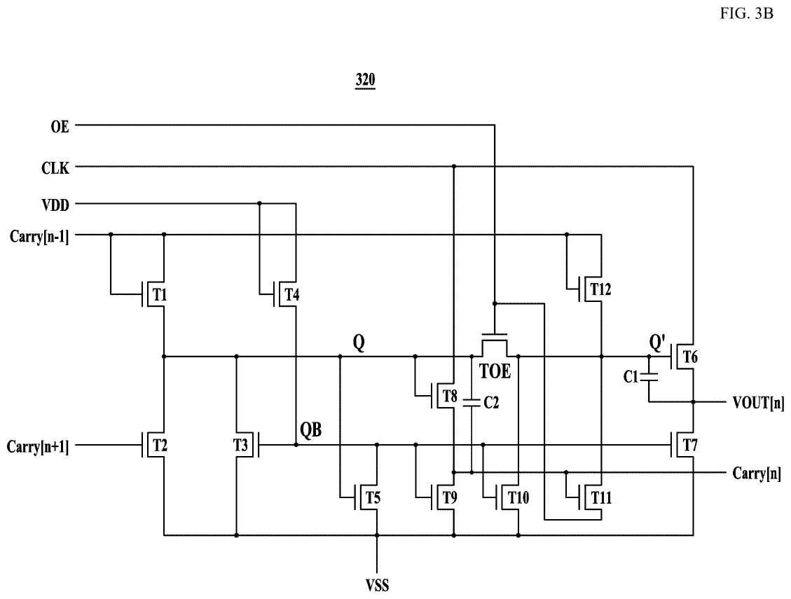

FIG. 3A is a diagram illustrating a specific example of a gate driving device 310 according to another embodiment.

Referring to FIG. 3A, TOE may be interpreted as the first transistor, T1 as the second transistor, and T2 as the third transistor.

As shown in FIG. 3A, a scanning pulse may be generated through the shift register, and when the Q node of an arbitrary shift register is pulled down, the T3 transistor serves as a TFT that holds the low state.

FIG. 3B is a diagram illustrating an example of a gate driving device 320 along with the detailed structure of a shift register.

In the embodiment shown in FIG. 3B, the first transistor may be interpreted as the TOE transistor, the second transistor as the T11 transistor, and the third transistor as the T12 transistor.

That is, the TOE transistor connects the Q node for generating a carry signal (Carry[n]) and the Q′ node for generating a final output signal (VOUT[n]). The Q node for generating the carry signal (Carry[n]) and the Q′ node for generating the final output signal (VOUT[n]) may be connected via the TOE transistor. Additionally, the TOE transistor may be controlled by the output enable (OE) signal.

Furthermore, the TOE transistor is turned on when the output enable (OE) signal is high, connecting the Q node for generating the carry signal (Carry[n]) and the Q′ node for generating the final output signal (VOUT[n]), thereby allowing both the final output signal (VOUT[n]) and the carry signal (Carry[n]) to be output simultaneously.

Additionally, the TOE transistor disconnects the Q node from the Q′ node when the output enable (OE) signal is low, while the T11 transistor pulls down the Q′ node using the output enable (OE) signal when the carry signal (Carry[n]) is output, thereby blocking the final output signal VOUT[n].

Furthermore, as soon as the output enable (OE) signal transitions from high to low, no output occurs. When the signal drops to low, the T11 transistor prevents the issue where the Q′ node of the next line remains floating high, which could cause unintended output. That is, when the output enable (OE) signal drops from high to low, the T11 transistor pulls down the input signal corresponding to the output signal.

Meanwhile, the T12 transistor ensures that pre-charging of the corresponding line occurs before the voltage of the output enable (OE) signal changes from low to high.

The gate driving circuit according to the present invention enables selective driving for an arbitrary line and may be implemented in a structure that controls the final output signal VOUT[n] using the carry signal Carry[n] and the output enable (OE) signal, without requiring programming for section configuration.

Additionally, a single output enable (OE) signal allows the configuration of multiple sections with different frequency ranges, including various high-frequency sections. By connecting the T11 transistor to the carry signal Carry[n] and the output enable (OE) signal, the pull-down operation of the Q′ node may be implemented with low power consumption.

The gate driving device 300 according to the present invention may connect VOUT[n-1] through T12 to ensure that pre-charging of the corresponding line occurs before the output enable (OE) signal transitions from low to high.

More specifically, the gate driving device 300 according to the present invention does not require a programming frame section for selective driving and may control the output waveform solely using the output enable (OE) signal. This provides the advantage of supporting multiple high-frequency regions. Additionally, it enables the implementation of multiple regions with different driving frequencies within a single screen.

As shown in FIG. 3B, the shift register may be configured using transistors T1, T2, T3, T4, T5, T8, and T9 to generate carry signals for all lines.

FIG. 3B illustrates the basic structure of a shift register, but any conventional circuit for generating pulses may be alternatively applied.

The Q node for generating the carry signal Carry[n] and the Q′ node for generating the final output signal VOUT[n] may be connected via the TOE TFT, and due to this structural characteristic, TOE is controlled by the output enable (OE) signal.

When the output enable (OE) signal is high, TOE is turned on, connecting the Q node and the Q′ node, allowing VOUT[n] and Carry[n] to be output simultaneously. When the output enable (OE) signal is low, the connection between the Q node and the Q′ node is cut off, enabling independent control of the Q′ node.

When the output enable (OE) signal is low, the T11 transistor pulls down the Q′ node using the output enable (OE) signal when Carry[n] is output, ensuring that VOUT[n] is not output.

The present invention allows for low-power pull-down operation.

Since the output enable (OE) signal determines whether VOUT[n] is output, it allows free control over any line, section size, or number of regions.

The inverted QB (Q_bar) signal of the Q node is connected to T10, ensuring that the Q′ node maintains a stable low voltage.

Finally, by connecting the T12 transistor to VOUT[n-1], it operates to ensure that pre-charging of the corresponding line occurs before the voltage of the output enable (OE) signal transitions from low to high.

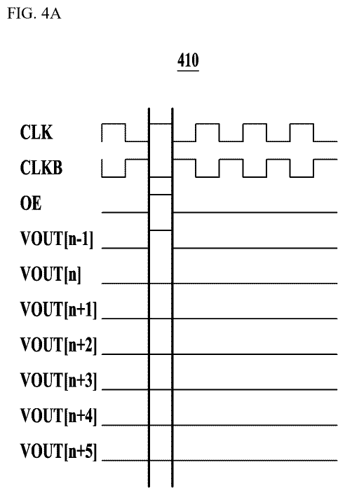

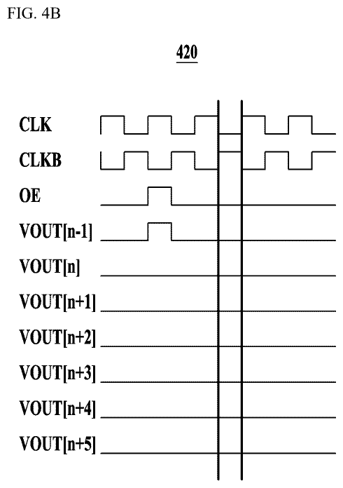

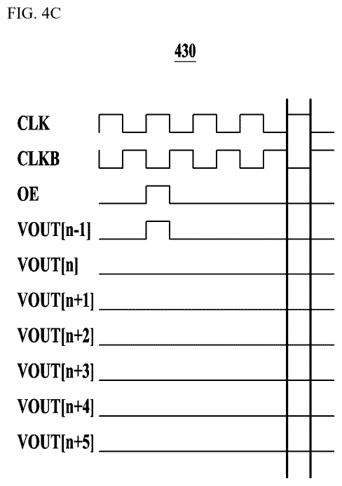

FIGS. 4A to 4C are diagrams illustrating an embodiment for generating a one-line output pulse.

According to the present invention, it is possible to freely configure various frequency regions simply by controlling the pulse width of the output enable (OE) signal, ranging from a single line, which is the smallest unit, to the entire set of lines.

FIGS. 4A to 4C illustrate timing diagrams in which an arbitrary one-line is selectively output based on the output enable (OE) signal at various positions.

Reference numeral 410 represents a timing diagram in which the third CLK is selected, and output is controlled based on the output enable (OE) signal.

Reference numeral 420 represents a timing diagram in which the sixth negative CLK is selected, and output is controlled based on the output enable (OE) signal.

Reference numeral 430 represents a timing diagram in which the ninth CLK is selected, and output is controlled based on the output enable (OE) signal.

In reference numeral 410 of FIG. 4A, if the T11 transistor is absent, when the output enable (OE) signal transitions from high to low, VOUT[n] would still produce an output. Additionally, if the T12 transistor is absent, the VOUT[n-1] pulse would not be generated.

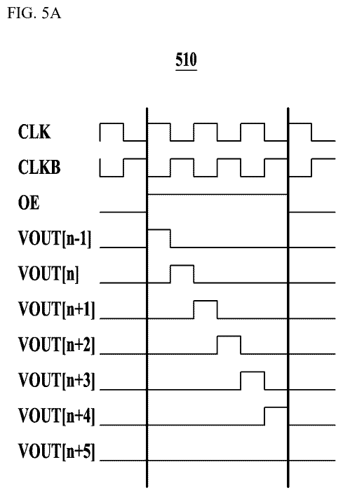

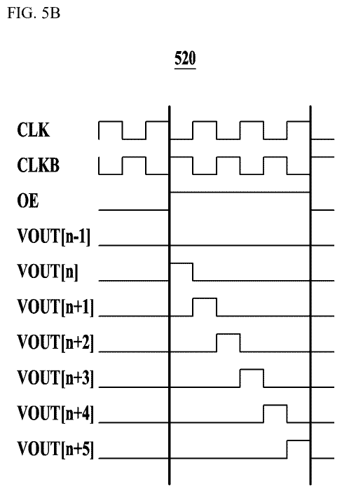

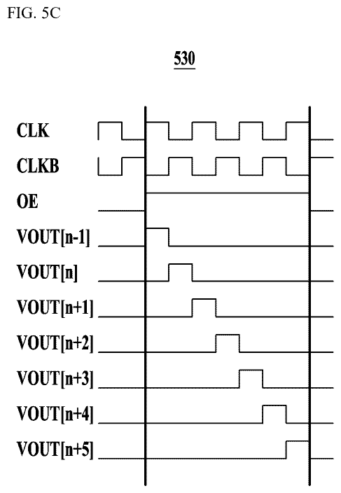

FIGS. 5A to 5C are diagrams illustrating an embodiment for generating seven-line output pulses.

FIGS. 5A to 5C represent timing diagrams 510, 520, and 530, where an arbitrary set of seven lines is selectively output based on the output enable (OE) signal.

Reference numeral 510 indicates that the output enable (OE) signal is used to output signals from the third CLK to the eighth CLK as the final output signal VOUT[n].

Reference numeral 520 indicates that the output enable (OE) signal is used to output signals from the fourth CLK to the ninth CLK as the final output signal VOUT[n].

Reference numeral 530 indicates that the output enable (OE) signal is used to output signals from the third CLK to the ninth CLK as the final output signal VOUT[n].

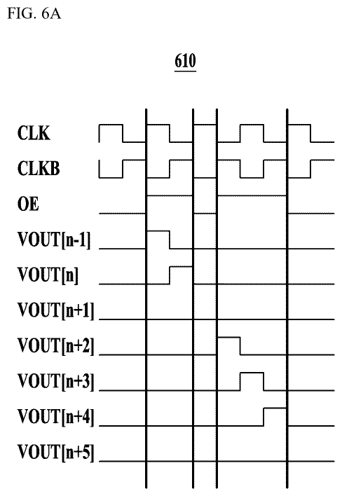

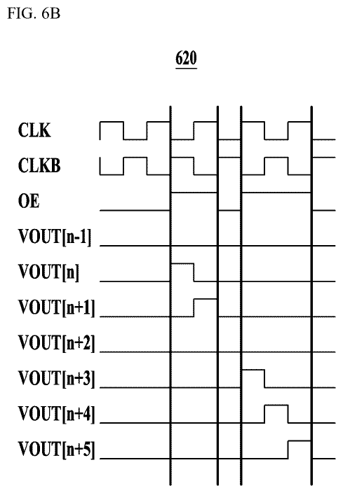

FIGS. 6A to 6B are diagrams illustrating an embodiment for generating output pulses when multiple pulse intervals exist.

Additionally, as shown in FIGS. 6A to 6B, by dividing the output enable (OE) signal into multiple signals, it is possible to implement multiple output pulse generation intervals, thereby supporting multiple high-frequency regions.

Reference numeral 610 indicates that the output enable (OE) signal is used to output signals from the third CLK to the fourth CLK and from the sixth CLK to the eighth CLK as the final output signal VOUT[n].

Reference numeral 620 indicates that the output enable (OE) signal is used to output signals from the fourth CLK to the fifth CLK and from the seventh CLK to the ninth CLK as the final output signal VOUT[n].

That is, the present invention does not require a programming frame interval for selective line driving and may control the output waveform solely through the output enable (OE) signal, thereby providing the advantage of supporting multiple high-frequency regions. Additionally, it enables the implementation of multiple regions with different driving frequencies within a single screen.

By utilizing the present invention, a TFT-based gate driving circuit may be provided that overcomes the limitations of gate driving circuits capable of selective line refresh rate control while achieving the same reduction in power consumption.

Furthermore, the present invention eliminates the need for a programming frame interval for selective driving, and by controlling the output waveform solely through the output enable (OE) signal, it supports multiple high-frequency regions and enables the implementation of multiple regions with different driving frequencies within a single screen.

As described above, although the embodiments have been explained with reference to limited drawings, various modifications and variations may be made by those skilled in the art based on the above descriptions.

For example, the described technologies may be performed in an order different from the described method, and/or the components of the described systems, structures, devices, circuits, and the like may be combined or arranged in a manner different from the described method, or may be replaced or substituted with other components or equivalents while still achieving appropriate results.

Therefore, other implementations, other embodiments, and equivalents to the scope of the following claims also fall within the scope of the claims.

What is claimed is:

1. A gate driving device capable of selective driving for an arbitrary line, comprising:
a pulse signal generation unit configured to generate a pulse signal for a line; and
a gate driving unit configured to selectively control an output value for an arbitrary line, the gate driving unit including:
a first transistor configured to control activation or deactivation of a final output signal (VOUT[n]);
a second transistor configured to pull down an input signal corresponding to the output signal to control whether the signal is output; and
a third transistor configured to maintain pre-charging of the line.

2. The gate driving device of claim 1, wherein the second transistor is configured to pull down input signal using an output enable (OE) signal to control whether signal is output.

3. The gate driving device of claim 1, wherein the third transistor is connected to output via the second transistor and is configured to maintain pre-charging of corresponding line to occur before voltage of output enable (OE) signal changes.

4. The gate driving device of claim 1, wherein the pulse signal generation unit includes a shift register configured to generate a pulse signal based on a plurality of transistors.

5. The gate driving device of claim 1, wherein the first transistor is configured to connect a Q node for generating a carry signal (Carry[n]) and a Q′ node for generating a final output signal (VOUT[n]).

6. The gate driving device of claim 1, wherein a Q node for generating a carry signal (Carry[n]) and the Q′ node for generating a final output signal (VOUT[n]) are connected by the first transistor, and the first transistor is controlled by an output enable (OE) signal.

7. The gate driving device of claim 1, wherein the first transistor is turned on when the output enable (OE) signal is high, connecting a Q node for generating a carry signal (Carry[n]) and a Q′ node for generating a final output signal (VOUT[n]), such that the final output signal (VOUT[n]) and a carry signal (Carry[n]) are output simultaneously.

8. The gate driving device of claim 7, wherein:
the first transistor disconnects the Q node from the Q′ node when the output enable (OE) signal is low; and
the second transistor pulls down the Q′ node using the output enable (OE) signal when the carry signal (Carry[n]) is output, thereby blocking output of the final output signal (VOUT[n]).

9. The gate driving device of claim 1, wherein the third transistor is configured to maintain pre-charging of a corresponding line before voltage of the output enable (OE) signal changes from low to high.
